(19) United States
(12) Patent Application Publication
(10) Pub. No.: US 2009/0101627 A1
(43) Pub. Date: Apr. 23, 2009

(54) ELECTRIC DISCHARGE MACHINE HAVING WIRE ELECTRODE CUTTING FUNCTION, AND WIRE ELECTRODE CUTTING METHOD

(75) Inventors: Akiyoshi KAWAHARA, Minamitsuru-gun (JP); Hiroyuki FURUKAWA, Minamitsuru-gun (JP)

Correspondence Address: LOWE HAUPTMAN HAM & BERNER, LLP, 1700 DIAGONAL ROAD, SUITE 300, ALEXANDRIA, VA, 22314, US

(73) Assignee: FANUC LTD, Minamitsuru-gun (JP)

(21) Appl. No.: 12/202,523

(22) Filed: Sep. 2, 2008

(30) Foreign Application Priority Data
Oct. 18, 2007 (JP) 2007-271733

(51) Int. Cl. B23H 7/08

(52) U.S. Cl. 219/69.12

(57) ABSTRACT

A wire electric discharge machine and a wire electrode cutting method capable of carrying out a wire electrode cutting process without need for an operator to input information on material or a diameter of a wire electrode. An electric current measuring device measures a value of an electrical current flowing through a wire electrode to which a voltage is applied. An electrical resistance of the wire electrode is detected based on the applied voltage and the measured value of the electrical current. A plurality of cutting conditions predetermined and stored for electrical resistances of different types of wire electrodes. A cutting condition for the wire electrode is determined based on the detected electrical resistance of the wire electrode and the stored plurality of cutting conditions, and the wire electrode is fusion-cut on the thus determined cutting condition.

### BACKGROUND OF THE INVENTION

1. Field of the Invention

The present invention relates to a wire electric discharge machine, and more particularly to an electric discharge machine having a wire electrode cutting function, and a wire electrode cutting method.

2. Description of Related Art

When machining a plurality of workpieces or cutting out a plurality of products from a single workpiece, a wire electric discharge machine sequentially inserts a wire electrode through machining start holes formed beforehand in the workpiece or workpieces, and executes electric discharge machining.

In such a case, a highly reliable automatic wire electrode cutting/connecting function is essentially required for the wire electric discharge machine to carry out a continuous unattended operation. With this function, a wire electrode is automatically cut after completion of machining started from a given machining start hole, and wire guides are moved to positions matching the next machining start hole. At such position the wire electrode is automatically connected, and the next machining is started.

As an automatic wire electrode cutting method, there is known a method for thermal fusion cutting of a wire electrode (Japanese Laid-open Patent Publication No. 2-53528 and Japanese Examined Patent Publication No. 7-106498). This method applies a voltage to a wire electrode to heat the wire electrode by its own electrical resistance, and at the same time applies a predetermined tension to the wire electrode, thereby fusion-cutting the wire electrode. Unlike a method for mechanically cutting a wire electrode by use of a cutter or the like, this method can form the cut end of the wire electrode into a pointed shape. At the wire electrode connecting operation, it is therefore possible to smoothly insert the wire electrode into guides and a machining start hole formed in a workpiece.

In a concentrated electric discharge detection apparatus for detecting the presence/absence of concentrated electric discharge in a wire electric discharge machine, there is a technique for detecting a variation in electrical resistance value between resistance measurement terminals, which are provided on opposite sides of a machining part of a wire electrode (JP 53-87089A). Another technique is also known that calculates a state of temperature of a wire electrode travelling to pass through a wire electric discharge part based on an electrical resistance value of the wire electrode, and measures whether or not the wire electrode reaches a temperature state where wire disconnection is liable to occur (JP 4-30916A).

In a wire electric discharge machine, various types of wire electrode are used, and a voltage to be applied to the wire electrode for the automatic wire electrode cutting therefore varies according to the type of wire electrode. Japanese Examined Patent Publication No. 7-106498 discloses a technique for determining, in response to the input of the size and type of a wire electrode to be cut, a wire tension and an electrical current value which are desired for the wire electrode cutting. This method is based on a precondition that a cutting condition is “input” by an operator, which poses a problem that the wire electrode cutting and connecting operation cannot correctly be carried out when the “input” is not correctly implemented.

To shorten a time period required for the wire cutting, the electric current supplied to the wire may be increased to increase the heating value of the wire so as to shorten a time period required for the wire to reach a temperature at or above which the wire can be cut. If the electric current is excessively large, however, the wire end becomes a spherical shape when the wire is cut, making it difficult for the wire to be smoothly inserted into a machining start hole at the wire connection, posing a problem that much time is required for the wire connection.

### SUMMARY OF THE INVENTION

The present invention automatically measures, prior to automatic execution of a wire electrode cutting and connecting operation, an electrical resistance value of a wire electrode, and carries out wire cutting at a voltage calculated based on the measured electrical resistance value or in a cutting condition determined from a table prepared beforehand in a memory, thereby realizing a highly reliable automatic wire electrode connecting operation.

A wire electric discharge machine of the present invention has a function of fusion-cutting a wire electrode. The wire electric discharge machine comprises: a voltage applying device for applying a voltage to the wire electrode; an electric current measuring device for measuring a value of an electrical current flowing through the wire electrode to which the voltage is applied; electrical resistance detecting means that detects an electrical resistance of the wire electrode based on the applied voltage and the measured value of the electrical current; storage means that stores a plurality of cutting conditions predetermined for electrical resistances of different types of wire electrodes; cutting condition determining means that determines a cutting condition for the wire electrode based on the electrical resistance of the wire electrode detected by the electrical resistance detecting means and the plurality of cutting conditions stored in the storage means; and means for fusion-cutting the wire electrode on the cutting condition determined by the cutting condition determining means.

The storage means may store a table indicating cutting conditions respectively for different electrical resistances of the wire electrodes.

The storage means may store a first table indicating types of wire electrodes respectively for electrical resistances of the wire electrodes, and a second table indicating cutting conditions respectively for the types of the wire electrodes.

A wire electrode cutting method of the present invention is for a wire electric discharge machine having a function of fusion-cutting a wire electrode. The method comprises the steps of: applying a voltage to the wire electrode; measuring a value of an electrical current flowing through the wire electrode to which the voltage is applied; detecting an electrical resistance of the wire electrode based on the applied voltage and the measured value of the electrical current; determining a wire electrode cutting condition based on the detected electrical resistance of the wire electrode and a plurality of cutting conditions which are predetermined for electrical resistances of different types of wire electrodes; and fusion-cutting the wire electrode on the determined cutting condition.

With the present invention, a wire electrode cutting process can be carried out without the need for the operator to input information on the material and diameter of the wire electrode, which are required for the wire electrode cutting process, whereby human-caused operation errors can be prevented.

With the wire electrode cutting method and the wire electric discharge machine with a wire electrode cutting function of the present invention, the wire cut end can be formed into a pointed shape suitable for the automatic wire connection.

With the present invention, a voltage applied to the wire electrode for execution of wire electrode cutting can be adjusted to an optimum value suited to the material and diameter of the wire electrode.

With the present invention, it is enough to control the applied voltage for the wire electrode cutting, and therefore the construction can be simplified as compared to a current-control-based arrangement for the wire electrode cutting.

### BRIEF DESCRIPTION OF THE DRAWINGS

FIG. 1 is a schematic view showing the construction of a wire electric discharge machine according to one embodiment of the present invention;

FIG. 2 is a schematic view showing the functions of a controller 3 shown in FIG. 1;

FIG. 3 is a schematic view showing the construction of a circuit for applying a voltage for measurement of an electrical resistance value of a wire electrode, a current measuring circuit, and a power supply circuit for the fusion-cutting of the wire electrode;

FIG. 4 is a graph showing a relation between an electrical resistance value of wire electrode and a voltage as a condition for the wire electrode cutting;

FIG. 5 is a graph showing a relation between an electrical resistance value of wire electrode and a wire electrode cutting voltage in a case that the heating value of the wire electrode is made constant; and

FIG. 6 is a flowchart showing the algorithm of a wire cutting process implemented by a CPU of the controller 3.

### DETAILED DESCRIPTION

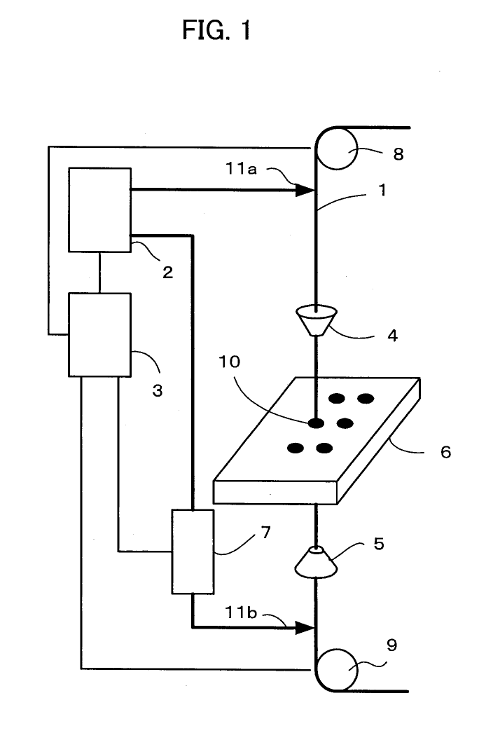

In the following, an embodiment of the present invention will be described referring to the appended drawings. FIG. 1 shows in schematic structural view one embodiment of a wire electric discharge machine of the present invention. Referring to FIG. 1, a wire electrode 1 is fed by a take-up roller 9 rotatably driven by a wire drive motor (not shown), while being guided by a brake-equipped roller 8, an upper guide 4, a workpiece 6 to be machined, and a lower guide 5. Conductors 11a, 11b are connected to the wire electrode 1, and a voltage for the wire fusion-cutting is applied to the wire electrode 1 from a power supply unit 2 via the conductors 11a, 11b. In order to supply both a voltage for identifying the wire electrode and a voltage for the wire electrode cutting from the same power supply, a wire electrode current detection unit 7 is inserted into a circuit for the wire electrode cutting, as shown in FIG. 1.

To identify the wire electrode, a monitoring voltage is applied to the wire electrode 1 to cause an electric current to flow therethrough. The wire electrode current detection unit 7 measures a value of the electric current and outputs the measured value to a controller 3. The controller 3 determines an electrical resistance value of the wire electrode 1, and identifies a type of the wire electrode based on the resistance value of the wire electrode 1.

After the type of the wire electrode 1 is identified, wire cutting is performed at a voltage calculated based on the measured electrical resistance value or in a cutting condition determined with reference to a table prepared beforehand in a memory.

A tension applying unit for applying a wire-cutting tension is constituted by the braking function of the brake-equipped roller 8 and the wire drive motor (not shown) for rotatably driving the take-up roller 9. The controller 3, which is a controller of the wire electric discharge machine, also serves as a controller of a wire cutting apparatus in this embodiment.

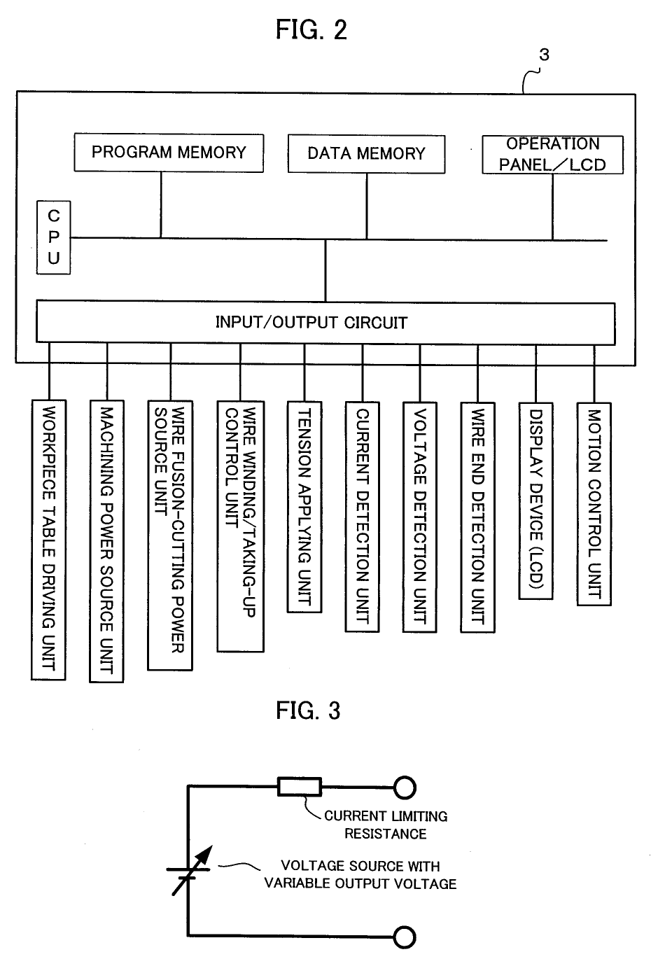

FIG. 2 schematically shows in function diagram the controller 3 in FIG. 1. The controller 3 includes a processor (CPU) to which a program memory, a data memory, an operation panel with liquid display LCD, and an input/output circuit are connected via a bus. The program memory stores various programs for controlling various sections and the controller per se of the wire electric discharge machine. The data memory includes position data associated with a machining program and various setting data that determine other machining conditions, and also serves as a memory in which data for calculations implemented by the CPU are temporarily stored.

Connected to the input/output circuit are a workpiece table driving unit, a machining power source unit, a wire fusion-cutting power source unit, a wire winding/taking-up control unit, a tension applying unit, a current detection unit, a voltage detection unit, a wire end detection unit, a display device (LCD), and a motion control unit for controlling other parts of the wire electric discharge machine. In a wire cutting process for the wire cutting, the controller 3 gives an instruction of a voltage value to the power supply unit 2 having the wire fusion-cutting power source unit, and gives an instruction of a tension value to the tension applying unit.

FIG. 3 schematically shows the construction of the power supply circuit for applying a voltage for measurement of an electrical resistance value of a wire electrode and for the fusion-cutting of the wire electrode. Based on the voltage value measured by the circuit shown in FIG. 3 and the current value detected by the wire electrode current detection unit 7 shown in FIG. 1, the CPU of the control circuit 3 in FIG. 2 calculates an electrical resistance value R of the wire electrode.

Table 1 shows wire electrode cutting conditions respectively corresponding to electrical resistance values R of wire electrode. When the electrical resistance value R of a wire electrode falls within a range of R₁≦R<R₂, the voltage as wire electrode cutting condition is made equal to V₁ and the tension as wire electrode cutting condition is made equal to T₁. For the resistance value R falling within a range of R₂≦R<R₃, the voltage and the tension as wire electrode cutting condition are made equal to V₂ and T₂, respectively. For the resistance value R falling within a range of R₃≦R<R₄, the voltage and the tension as wire electrode cutting condition are made equal to V₃ and T₃, respectively.

TABLE 1
Relations between electrical resistance values of wire
electrode and cutting conditions

| Electrical | Wire electrode | Wire electrode | Wire electrode |
|---|---|---|---|
| resistance value | cutting | cutting | cutting |
| of wire electrode | condition | condition | condition |
| (R) | (Voltage) | (Tension) | ( . . . ) |
| R1 ≦ R < R2 | V1 | T1 | |
| R2 ≦ R < R3 | V2 | T2 | |
| R3 ≦ R < R4 | V3 | T3 | |

Table 2 shows relations between electrical resistance values R of wire electrode and types of wire electrode. When the electrical resistance value R of a wire electrode falls within a range of R₁≦R<R₂, it is determined that the wire electrode being used is made of a material M1 and has a diameter of F1. For the resistance value R falling within a range of R₂≦R<R₃, it is determined that the wire electrode being used is made of a material M₂ and has a diameter of F₂. For the resistance value R falling within a range of R₃≦R<R₄, it is determined that the wire electrode being used is made of a material M₃ and has a diameter of F₃

TABLE 2
Relations between types of wire electrode and cutting conditions

| Electrical resistance value of wire | Material and diameter of wire |
|---|---|
| electrode (R) | electrode |
| R1 ≦ R < R2 | M1, F1 |
| R2 ≦ R < R3 | M2, F2 |
| R3 ≦ R < R4 | M3, F3 |

Table 3 shows cutting conditions respectively corresponding to types of wire electrode. Specifically, the cutting voltage and the cutting tension are respectively made equal to V₁ and T₁ for a wire electrode made of material M₁ and having diameter of F₁. The cutting voltage and the cutting tension are made equal to V₂ and T₂ for a wire electrode made of material M₂ and having a diameter of F₂, and made equal to V₃ and T₃ for a wire electrode made of material M₃ and having a diameter of F₃, respectively.

TABLE 3
Relations between types of wire electrode and cutting conditions

| Material and | | | |
|---|---|---|---|
| diameter | Wire electrode | Wire electrode | Wire electrode |
| of wire | cutting condition | cutting condition | cutting condition |
| electrode | (Voltage) | (Tension) | ( . . . ) |
| M1, F1 | V1 | T1 | |
| M2, F2 | V2 | T2 | |
| M3, F3 | V3 | T3 | |

The relations shown in Table 1 between electrical resistance values R of wire electrode and cutting conditions (voltage, tension, etc.) are stored in advance in the data memory of the controller 3. Alternatively, the relations shown in Table 2 between electrical resistance values R of wire electrode and types of wire electrode (materials and diameters of wire electrode) and the relations shown in Table 3 between types of wire electrode and cutting conditions (voltage, tension, etc.) are stored in advance in the data memory of the controller 3. By separating the storage into Tables 2 and 3, the material and diameter of the wire electrode can be identified, and existing data on wire electrode cutting condition can easily be transplanted to the electric discharge machine of the present invention.

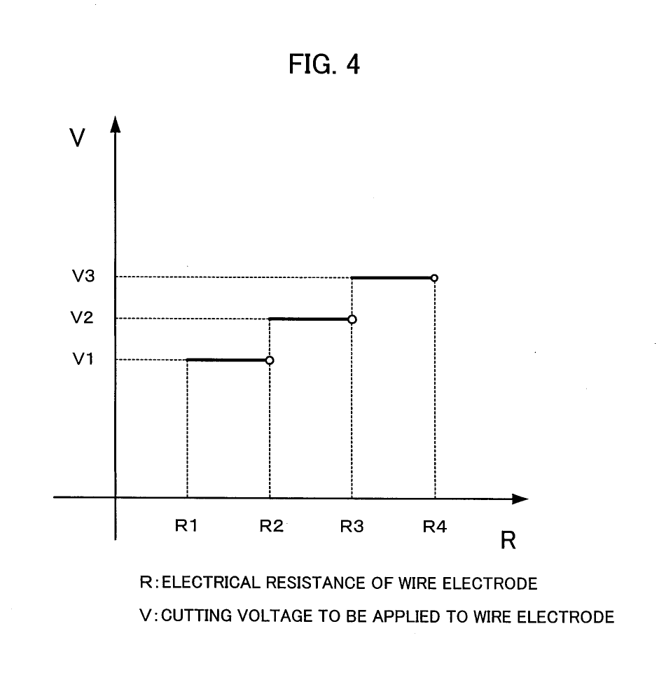

FIG. 4 shows a relation shown in Table 1 between the electrical resistance value R of wire electrode and the cutting voltage V to be applied to wire electrode, which is one of wire electrode cutting conditions, and indicates that the voltage V to be applied to wire electrode can be determined based on the electrical resistance value R of wire electrode calculated by the CPU of the controller 3 in FIG. 2.

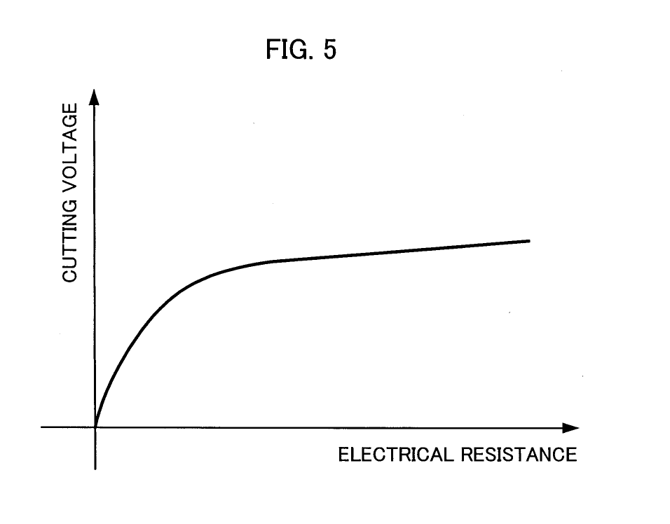

FIG. 5 shows a relation between the electrical resistance value of wire electrode and the cutting voltage in a case that a voltage for making the heating value of the wire electrode constant is optimized. Assuming that the heating value of the wire electrode is represented by P, the voltage applied to the wire electrode is represented by V, the electric current flowing through the wire electrode is represented by I, and the electrical resistance value of the wire electrode is represented by R, a relation shown by expression (1) is satisfied: P=VI=V²/R . . . (1). From expression (1), expression (2) is obtained: V=\sqrt{PR} . . . (2). Since the heating value is constant, the relation between the wire electrode cutting voltage and the wire electrode resistance value is represented by a graph shown in FIG. 5.

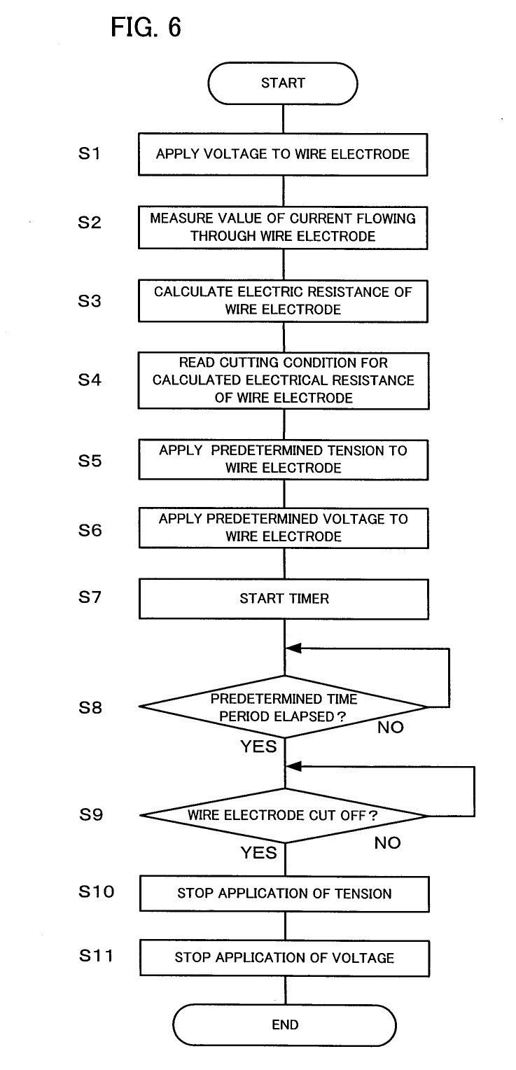

FIG. 6 shows in flowchart the algorithm of a wire cutting process implemented by the CPU of the controller 3. The wire cutting process is substantially executed after completion of electric discharge machining at one place of the workpiece 6. First, to measure the electrical resistance value of the wire electrode 1, a predetermined voltage is applied via the conductors to the wire electrode 1 (Step S1), and a value of electrical current flowing through the wire electrode 1 at that time is measured (Step S2). From the voltage applied to the wire electrode 1 at Step S1 and the value of electric current flowing through the wire electrode 1 measured at Step S2, an electrical resistance value of the wire electrode is calculated (Step S3). Based on the electrical resistance value of the wire electrode 1 calculated in Step S3, a cutting condition (a predetermined voltage value and a predetermined tension value) stored beforehand in the wire electrode cutting condition storage means in the memory is read out (Step S4). The predetermined voltage value and the predetermined tension value are set in advance as a condition in which the cut end of a fusion-cut wire is formed into a pointed-shape. The cutting condition includes not only the values of voltage and tension to be applied to the wire electrode, but also other parameters such as a wire electrode temperature and a time period elapsed from the start of voltage application.

Next, the tension applying unit is driven to apply the tension of the predetermined value to the wire electrode 1 (Step S5), and the predetermined voltage is applied from the power supply unit 2 to the wire electrode 1 (Step S6). A timer that measures a time period elapsed from the start of wire cutting is reset and then started (Step S7), whereupon the flow proceeds to Step S8. In Step S8, it is monitored whether or not the time period elapsed from the start of wire cutting and measured by the timer reaches a predetermined time period. In Step S9, it is determined whether or not the wire electrode is cut off after elapse of the predetermined time period for which the predetermined voltage is applied, and if the answer is NO, the determination is repeated.

When it is determined in Step S9 that the wire electrode 1 is cut off, the application of tension is stopped (Step S10), the application of voltage from the power supply unit 2 is stopped (Step S11), and the wire cutting process is completed.

It should be noted that the processing in Steps S1 to S4 is carried out at completion of the wire electric discharge machining operation at a single initial place, to thereby obtain an electrical resistance value R of the wire electrode, which is then stored into the data memory of the controller 3. At the next place, the stored electrical resistance value R of the wire electrode may be used, whereby a further measurement of the electrical resistance value R of the wire electrode can be omitted.

What is claimed is:

1. A wire electric discharge machine having a function of fusion-cutting a wire electrode, comprising:
a voltage applying device for applying a voltage to the wire electrode;
an electric current measuring device for measuring a value of an electrical current flowing through the wire electrode to which the voltage is applied;
electrical resistance detecting means that detects an electrical resistance of the wire electrode based on the applied voltage and the measured value of the electrical current;
storage means that stores a plurality of cutting conditions predetermined for electrical resistances of different types of wire electrodes;
cutting condition determining means that determines a cutting condition for the wire electrode based on the electrical resistance of the wire electrode detected by said electrical resistance detecting means and the plurality of cutting conditions stored in said storage means; and
means for fusion-cutting the wire electrode on the cutting condition determined by said cutting condition determining means.

2. A wire electric discharge machine according to claim 1, wherein said storage means stores a table indicating cutting conditions respectively for different electrical resistances of the wire electrodes.

3. A wire electric discharge machine according to claim 1, wherein said storage means stores a first table indicating types of wire electrodes respectively for electrical resistances of the wire electrodes, and a second table indicating cutting conditions respectively for the types of the wire electrodes.

4. A wire electrode cutting method for a wire electric discharge machine having a function of fusion-cutting a wire electrode, comprising the steps of:
applying a voltage to the wire electrode;
measuring a value of an electrical current flowing through the wire electrode to which the voltage is applied;
detecting an electrical resistance of the wire electrode based on the applied voltage and the measured value of the electrical current;
determining a wire electrode cutting condition based on the detected electrical resistance of the wire electrode and a plurality of cutting conditions which are predetermined for electrical resistances of different types of wire electrodes; and
fusion-cutting the wire electrode on the determined cutting condition.
